(19) United States
(12) Patent Application Publication
(10) Pub. No.: US 2007/0090750 A1
(43) Pub. Date: Apr. 26, 2007

(54) Electron emission device and electron emission display using the same

(75) Inventors: Sang-Jo Lee, Yongin-si (KR); Chun-Gyoo Lee, Yongin-si (KR); Sang-Ho Jeon, Yongin-si (KR); Sang-Hyuck Ahn, Yongin-si (KR); Su-Bong Hong, Yongin-si (KR); Jong-Hoon Shin, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/580,931

(22) Filed: Oct. 16, 2006

(30) Foreign Application Priority Data
Oct. 25, 2005 (KR) 10-2005-0100655

(51) Int. Cl. H01J 63/04; H01J 1/62

(52) U.S. Cl. 313/496

(57) ABSTRACT

An electron emission device includes a substrate with an effective area and a pad area placed external to the effective area. Cathode electrodes are formed on the substrate. Electron emission regions are formed at the cathode electrodes within the effective area. Gate electrodes are separately insulated from the cathode electrodes by interposing an insulating layer, and have opening portions to expose the electron emission regions. The respective gate electrodes have an effective portion located at the effective area with a first line width, and a pad portion located at the pad area with a second line width. When the line width subtracted from the first line width by the whole line width of the opening portions placed in the width direction of the effective portion is defined as an effective line width, the second line width is established to be larger than the effective line width.

### CROSS-REFERENCE TO RELATED APPLICATIONS

This application claims priority to and benefit of Korean Patent Application No. 2005-100655 filed on Oct. 25, 2005, in the Korean Intellectual Property Office, the entire contents of which are incorporated herein by reference.

### BACKGROUND OF THE INVENTION

1. Field of the Invention

Aspects of the present invention relate to an electron emission device and an electron emission display using the electron emission device, and in particular, to an electron emission device that has gate electrodes with optimized line width at an effective area as well as at a pad area.

2. Description of the Related Art

Generally, electron emission elements are classified, depending upon the kinds of electron sources, into a first type using a hot cathode, and a second type using a cold cathode. Among the second type of electron emission elements using a cold cathode there is known a field emitter array (FEA) type, a surface conduction emission (SCE) type, a metal-insulator-metal (MIM) type, and a metal-insulator-semiconductor (MIS) type.

The FEA type of electron emission element has electron emission regions, and cathode and gate electrodes as the driving electrodes for controlling the emission of electrons from the electron emission regions. The electron emission regions are formed with a material having a low work function or a high aspect ratio. For instance, the electron emission regions are formed with a carbonaceous material such as carbon nanotubes (CNTs), graphite, and diamond-like carbon (DLC). With the usage of such a material for the electron emission regions, when an electric field is applied to the electron emission regions under a vacuum atmosphere, electrons are easily emitted from those electron emission regions.

Arrays of the electron emission elements are arranged on a first substrate to form an electron emission device. A light emission unit is formed on a second substrate with phosphor layers and an anode electrode, which is assembled with the first substrate, thereby forming an electron emission display.

That is, the common electron emission device includes electron emission regions, and a plurality of driving electrodes functioning as scan and data electrodes, which are operated to thereby control the on/off and amount of electron emission for the respective pixels. With the electron emission display device, the electrons emitted from the electron emission regions excite phosphor layers, thereby emitting light or displaying the desired images.

With the known FEA type of electron emission device, cathode electrodes are stripe-patterned in a direction of a substrate, and an insulating layer covers the cathode electrodes. Gate electrodes are stripe-patterned on the insulating layer in a direction crossing the cathode electrodes, a plurality of opening portions is formed in the gate electrodes and the insulating layer to partially expose the surface of the cathode electrodes, and electron emission regions are formed on the cathode electrodes internal to the opening portions.

The cathode and gate electrodes are respectively drawn at one end thereof from the effective area of the electron emission regions to the pad area of the periphery of the substrate to control the electron emission for the respective pixels. The cathode and gate electrodes are electrically connected to a scan driver or a data driver at the pad area by way of a connector like a flexible printed circuit (FPC) to receive a scan driving voltage or a data driving voltage therefrom.

As several connectors are normally arranged along one side periphery of the substrate to connect the electrodes to an external circuit, a marginal space should be provided at the pad area to avoid interference among the connectors and to form alignment marks. For this purpose, it is common to make the electrode pitch and the electrode line width at the pad area smaller than those at the effective area.

However, in the case where the electrode line width is not properly controlled at the pad area as well as at the effective area, that is, when the electrode line width is too small at the pad area, the electrode portion at the pad area involves a high resistance, and the driving efficiency at the effective area deteriorates. Particularly, as the gate electrodes have a plurality of opening portions at the effective area to expose the electron emission regions, there is a difficulty in establishing the electrode line width at the pad area in view of only the electrode line width at the effective area.

### SUMMARY OF THE INVENTION

An aspect of the present invention is to provide an electron emission device that optimizes the line width of gate electrodes at the effective area as well as at the pad area in consideration of the shape characteristic of the gate electrodes to thereby heighten the driving efficiency. Another aspect of the present invention is to provide an electron emission display device that uses the electron emission device. These and/or other objects may be achieved by an electron emission device with the following features.

According to one aspect of the present invention, an electron emission device includes a substrate with an effective area and a pad area placed external to the effective area. Cathode electrodes are formed on the substrate, and electron emission regions are formed at the cathode electrodes within the effective area. Gate electrodes are separately insulated from the cathode electrodes by interposing an insulating layer, and the gate electrodes and insulating layer have opening portions to expose the electron emission regions. The respective gate electrodes have an effective portion located at the effective area with a first line width, and a pad portion located at the pad area with a second line width. When an effective line width is defined as a difference between the first line width and a total line width of the opening portions placed in the width direction of the effective portion, the second line width is established to be larger than the effective line width.

While not required in all aspects, the respective gate electrodes may be structured to satisfy the following condition:
P2≧(P1+P3)/2
where P1 indicates the first line width, P2 indicates the second line width, and P3 indicates the effective line width.

While not required in all aspects, the respective gate electrodes may further have a variable width portion disposed between the effective portion and the pad portion, and the variable width portion may be gradually increased in width from the pad portion toward the effective portion.

According to another aspect of the present invention, an electron emission display device includes a first substrate with an effective area and a pad area placed external to the effective area. A second substrate faces the first substrate, the second substrate having phosphor layers disposed thereon corresponding to the effective area. Cathode electrodes are formed on the first substrate, and electron emission regions are formed at the cathode electrodes within the effective area. Gate electrodes are separately insulated from the cathode electrodes by interposing an insulating layer, and the gate electrodes and insulating layer have opening portions to expose the electron emission regions. An anode electrode is formed on a surface of the phosphor layers. The respective gate electrodes have an effective portion located at the effective area with a first line width, and a pad portion located at the pad area with a second line width smaller than the first line width. When an effective line width is defined as a difference between the first line width and a total line width of the opening portions placed in the width direction of the effective portion, the second line width is established to be larger than the effective line width.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A is a partial exploded perspective view of an electron emission display according to an embodiment of the present invention;

FIG. 1B is an enlarged view of the “I” portion shown in FIG. 1A;

FIG. 2 is a partial sectional view of an electron emission display according to an embodiment of the present invention; and

FIG. 3 is a partial enlarged plan view of the gate electrode shown in FIG. 1.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

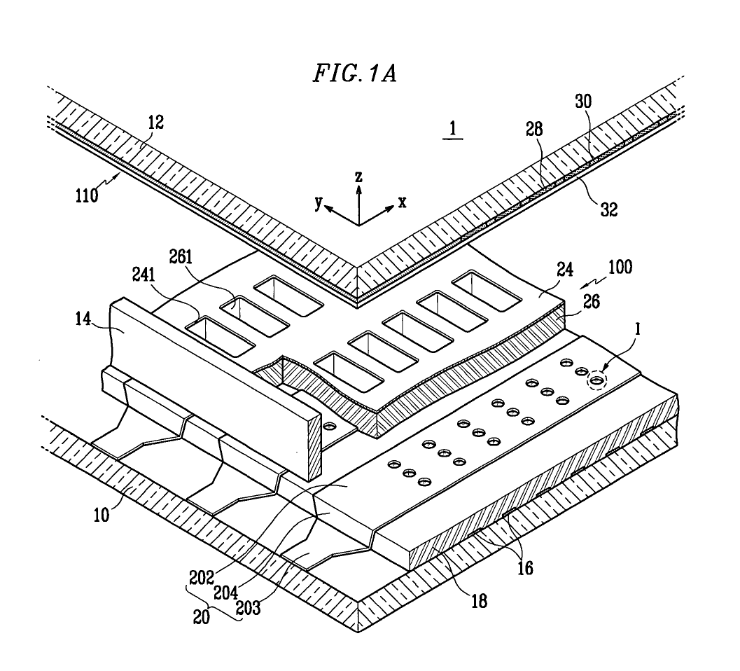

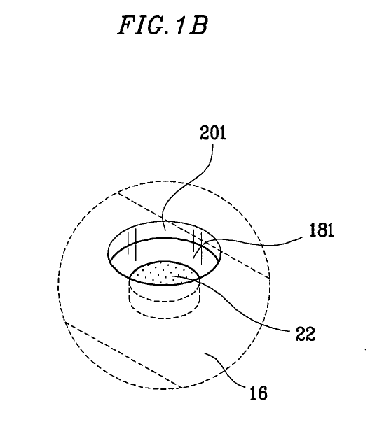

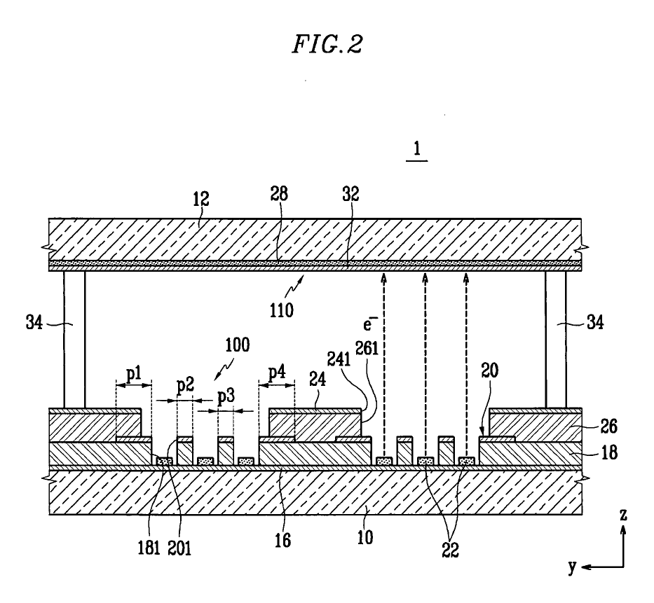

FIG. 1A is a partial exploded perspective view of an electron emission display according to an embodiment of the present invention, and FIG. 1B is an enlarged view of the “I” portion shown in FIG. 1A. FIG. 2 is a partial sectional view of an electron emission display according to an embodiment of the present invention. As shown in FIGS. 1A to 2, the electron emission display 1 includes first and second substrates 10 and 12 facing each other in parallel, with a predetermined distance therebetween. The first and second substrates 10 and 12 are sealed to each other at the peripheries thereof by a sealing member 14 to form a vessel, and the internal space of the vessel is evacuated to a vacuum pressure of about 10⁻⁶ torr, thereby constructing a vacuum vessel.

Arrays of electron emission elements are arranged on a surface of the first substrate 10 facing the second substrate 12 to form an electron emission device 100 together with the first substrate 10. The electron emission device 100 forms an electron emission display together with the second substrate 12 and a light emission unit 110 provided on the second substrate 12.

Cathode electrodes 16 being the first electrodes are stripe-patterned on the first substrate 10 in a direction (y axis direction of the FIG. 1A) thereof, and a first insulating layer 18 is formed on the entire surface area of the first substrate 10 such that it covers the cathode electrodes 16. Gate electrodes 20 being the second electrodes are stripe-patterned on the first insulating layer 18 perpendicular to the cathode electrodes 16.

In this embodiment, when the crossed region of a cathode electrode 16 and a gate electrode 20 is defined as a pixel, one or more electron emission regions 22 are formed on the cathode electrodes 16 at respective pixels, and opening portions 181 and 201 are formed in the first insulating layer 18 and the gate electrodes 20 corresponding to the respective electron emission regions 22 to expose the electron emission regions 22 on the first substrate 10.

The electron emission regions 22 are formed with a material that emits electrons when an electric field is applied thereto under a vacuum atmosphere, such as a carbonaceous material or a nanometer (nm) size material. For instance, the electron emission regions 22 may be formed with carbon nanotubes (CNTs), graphite, graphite nanofiber, diamond, diamond-like carbon (DLC), C₆₀, silicon nanowire, or a combination thereof by way of screen printing, direct growth, sputtering, or chemical vapor deposition (CVD).

A focusing electrode 24 being the third electrode is formed on the gate electrodes 20 and the first insulating layer 18. A second insulating layer 26 is placed between the focusing electrode 24 and the gate electrodes 20 to insulate the gate electrodes 20 and the focusing electrode 24 from each other. Opening portions 241 and 261 are formed in the focusing electrode 24 and the second insulating layer 26 to pass the electron beams. The respective opening portions 241 and 261 are each formed at each respective pixel such that the focusing electrode 24 can collectively focus the electrons emitted from one pixel. That is, with the above-described structure, one electron emission element has a first insulating layer 18, a focusing electrode 24, a second insulating layer 26, and electron emission regions 22, which are placed at each pixel.

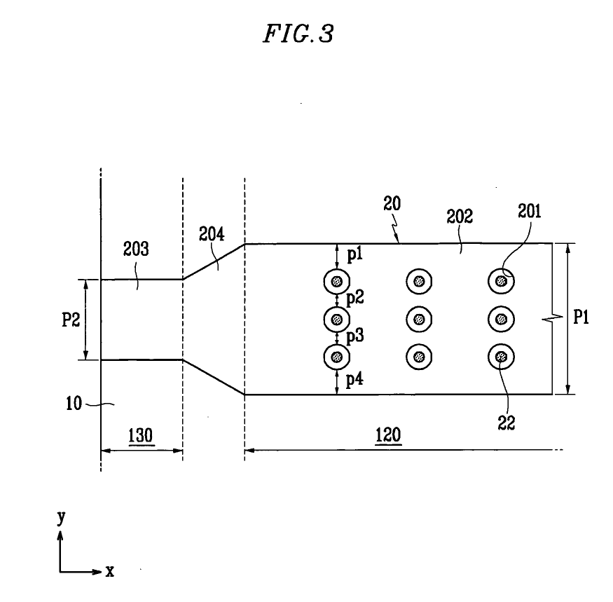

FIG. 3 is a partial enlarged plan view of the gate electrode shown in FIG. 1A. As shown in FIG. 3, the first substrate 10 has an effective area 120 of the electron emission regions 22 to practically emit electrons due to the operation of the cathode and gate electrodes 16 and 20, and a pad area 130 of the periphery thereof external to the effective area 120. Each gate electrode 20 has an effective portion 202 placed at the effective area 120 with a first line width P1, a pad portion 203 placed at the pad area 130 with a second line width P2 smaller than the first line width P1, and a variable width portion 204 interconnecting the effective portion 202 and the pad portion 203.

The pad portion 203 is connected to an external circuit by way of a connector (not shown) such as a flexible printed circuit (FPC) to receive a driving voltage therefrom, and the driving voltage applied to the pad portion 203 is transmitted to the effective portion 202 via the variable width portion 204. The variable width portion 204 is gradually increased in line width from the pad portion 203 toward the effective portion 202 to thereby prevent the gate electrode 20 from radically varying in line width.

As described above, the pad portion 203 receives a driving voltage from the external circuit, and the effective portion 202 controls the electron emission with the driving voltage transmitted via the pad portion 203 utilizing the voltage difference thereof from the cathode electrode 16. Accordingly, the ratio of the second line width P2 to the first line width P1 largely affects the resistance characteristic of the pad portion 203 and the emission control characteristic of the effective portion 202.

The effective portion 202 is basically stripe-shaped with a first line width P1, but is provided with a plurality of opening portions 201 to expose the electron emission regions 22 of the respective pixels where it crosses the cathode electrodes 16. Therefore, the line width of the effective portion 202 at each pixel is practically smaller than the first line width P1.

With the above-described structure, when the line width of the effective portion at the pixel is conveniently referred to as an “effective line width,” the effective line width P3 is a value obtained when the total width of the opening portions 201 located in the width direction of the gate electrode 20 is subtracted from the first line width P1. That is, as shown in the drawing, assuming that three opening portions 201 are arranged in parallel in the width direction of the gate electrode 20, the effective line width P3 can be expressed by the following formula:
P3=p1+p2+p3+p4 (1)
where p1 and p4 are the distances between the outermost opening portions 201 and the ends of the effective portion 202 sided therewith, respectively, and p2 and p3 are the distances between the opening portions 201. The values of p1 to p4 are all measured along the line passing over the centers of all the opening portions 202.

In this embodiment, the respective gate electrodes 20 are structured to satisfy the following condition:
P2≧P3 (2)

With the above condition, when the second line width P2 is established to be smaller than the effective line width P3, higher resistance is applied by the pad portion 203 with the second line width P2 rather than by the pixel with the effective line width P3 so that the driving efficiency deteriorates, and it becomes difficult to control the emission at the pixel. Accordingly, with the electron emission device according to aspects of the present embodiment, the second line width P2 is established to be smaller than the first line width P1 such that a marginal space is provided at the pad area 120, and the second width P2 is established to be larger than the effective line width P3 such that the resistance of the pad portion 203 is lowered and the driving efficiency is heightened.

Furthermore, with the present embodiment, the respective gate electrodes 20 are structured to satisfy the following condition:
P2≧(P1+P3)/2 (3)

The formula 3 considers the total first line width P1 and the effective line width P3 when the resistance at the effective portion 202 of the gate electrode 10 is estimated. The second line width P2 is established to be more than the average value of the first line width P1 and the effective line width P3. When the condition of Formula 3 is satisfied, the resistance of the pad portion 203 is lowered to thereby heighten the driving efficiency.

Phosphor layers 28 with red, green and blue phosphors are arranged on a surface of the second substrate 12 facing the first substrate 10 such that they are spaced apart from each other by a distance, and a black layer 30 is disposed between the respective phosphor layers 28 to enhance the screen contrast. An anode electrode 32 is formed on the phosphor and the black layers 28 and 30 of an aluminum-like metallic material.

The anode electrode 32 receives a high voltage required to accelerate the electron beams emitted from the electron emission regions 22 to excite the phosphor layers 28 to a high potential state, and the anode electrode 32 reflects the visible light radiated from the phosphor layers 28 toward the first substrate 10 back toward the second substrate 12, thereby heightening the screen luminance.

Alternatively, the anode electrode may be formed of a transparent conductive material such as indium tin oxide (ITO), instead of the metallic material. In this case, the anode electrode is placed on a surface of the phosphor and the black layers 28 and 30 directed toward the second substrate 12. Furthermore, it is also possible to simultaneously use a transparent conductive layer and a metallic layer as the anode electrode.

As shown in FIG. 2, a plurality of spacers 34 is arranged between the first and second substrates 10 and 12 to endure the pressure applied to the vacuum vessel and sustain the distance between the two substrates to be constant. The spacers 34 are placed at the area of the black layer 30 such that they do not intrude upon the area of the phosphor layers 28.

The above-structured electron emission display is driven by supplying predetermined voltages to the cathode electrodes 16, the gate electrodes 20, the focusing electrode 24, and the anode electrode 32 from the outside. For instance, either of the cathode electrodes 16 and the gate electrodes 20 receive scan driving voltages to function as the scan electrodes, and the other receive data driving voltages to function as the data electrodes.

The focusing electrode 24 receives a voltage required to focus electron beams, for instance, 0V, or a negative direct current voltage of several to several tens of volts. The anode electrode 32 receives a voltage required to accelerate the electron beams, for instance, a positive direct current voltage of several hundreds to several thousands of volts.

Then, electric fields are formed around the electron emission regions 22 at the pixels where the voltage difference between the cathode and gate electrodes 16 and 20 exceeds the threshold value, and electrons are emitted from the electron emission regions 22 due to the electric fields. The emitted electrons are centrally focused into a bundle of electron beams while passing the opening portion 241 of the focusing electrode 24. The focused electron beams attracted by the high voltage applied to the anode electrode 32, collide against the phosphor layers 28 at the relevant pixels, thereby exciting them and emitting light.

With the driving process of the electron emission display according to aspects of the present embodiment, as the line width of the gate electrode 20 is optimized as above, a marginal space is provided at the pad area 120, and the resistance of the pad portion 203 is lowered, thereby heightening the emission control characteristic of the effective portion 202.

As described above, with an electron emission display device according to aspects of the present invention, the pad portion of the gate electrode is established to be smaller in line width than the effective portion, so that a marginal space is provided at the pad area. Furthermore, the line width of the pad portion is established to be larger than the effective line width so that the resistance of the pad portion is lowered, and the emission control characteristic is heightened, thereby obtaining excellent display quality.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electron emission device comprising:
a substrate with an effective area and a pad area placed external to the effective area;
cathode electrodes formed on the substrate;
electron emission regions formed at the cathode electrodes within the effective area; and
gate electrodes separately insulated from the cathode electrodes by an interposed insulating layer and the gate electrode and the interposed insulating layer having corresponding opening portions to expose the electron emission regions,
wherein each gate electrode has an effective portion located at the effective area with a first line width and a pad portion located at the pad area with a second line width, and
wherein when a line width subtracted from the first line width by the whole line width of the opening portions placed in the width direction of the effective portion is defined as an effective line width, the second line width is established to be larger than the effective line width.

2. The electron emission device of claim 1, wherein the gate electrodes to satisfy the following condition:
P2≧(P1+P3)/2
wherein P1 indicates the first line width, P2 indicates the second line width, and P3 indicates the effective line width.

3. The electron emission device of claim 1, wherein the gate electrode further comprises a variable width portion disposed between the effective portion and the pad portion.

4. The electron emission device of claim 3, wherein the variable width portion is gradually increased in width from the pad portion toward the effective portion.

5. The electron emission device of claim 1, further comprising a focusing electrode placed over the gate electrodes such that the focusing electrode is insulated from the gate electrodes.

6. The electron emission device of claim 1 wherein the electron emission regions comprise at least one material selected from the group consisting of carbon nanotubes (CNTs), graphite, graphite nanofiber, diamond, diamond-like carbon (DLC), C₆₀, and silicon nanowire.

7. An electron emission display comprising:
an electron emission device, comprising:
a substrate with an effective area and a pad area placed external to the effective area,
cathode electrodes formed on the substrate,
electron emission regions formed at the cathode electrodes within the effective area, and
gate electrodes separately insulated from the cathode electrodes by an interposed insulating layer and the gate electrodes and the interposed insulating layer having corresponding opening portions to expose the electron emission regions, wherein the respective gate electrodes have an effective portion located at the effective area with a first line width, and a pad portion located at the pad area with a second line width, wherein when the line width subtracted from the first line width by the whole line width of the opening portions placed in the width direction of the effective portion is defined as an effective line width, the second line width is established to be larger than the effective line width;
a counter substrate facing the substrate;
phosphor layers formed on a surface of the counter substrate; and
an anode electrode formed on a surface of the phosphor layers.

8. The electron emission display of claim 7, wherein the gate electrodes to satisfy the following condition:
P2≧(P1+P3)/2
wherein P1 indicates the first line width, P2 indicates the second line width, and P3 indicates the effective line width.

9. The electron emission display of claim 8, wherein the effective line width, P3 is expressed by:
$$P 3 = p 1 + {\sum }_{i = 2}^{n - 1} {p}_{i} + {p}_{n}$$
when the number of openings is 4 or greater, wherein p1 and pₙ are the distances between the outermost opening portions and the ends of the effective portion sided therewith, respectively, pi are distances between the openings, and n is the number of openings wherein p1 to pₙ are all measured along a line passing over centers of all the openings.

10. The electron emission display of claim 7, wherein the gate electrode further comprises a variable width portion disposed between the effective portion and the pad portion.

11. The electron emission display of claim 10, wherein the variable width portion is gradually increased in width from the pad portion toward the effective portion.

12. The electron emission display of claim 7, further comprising a focusing electrode placed over the gate electrodes such that the focusing electrode is insulated from the gate electrodes.

13. The electron emission display of claim 7, wherein the electron emission regions comprise at least one material selected from the group consisting of carbon nanotubes (CNTs), graphite, graphite nanofiber, diamond, diamond-like carbon (DLC), C₆₀, and silicon nanowire.

14. An electron emission device comprising:
cathode electrodes formed on a substrate to carry a voltage;
electron emission regions formed at the cathode electrodes within an effective area;
a gate electrode to emit electrons from the electron emission regions, wherein the line width of the gate electrode is greater in a pad area than an effective line width of the gate electrode in the effective area, to lower a resistance of the gate electrode in the pad area below a resistance of the gate electrode in the effective area.

15. The electron emission device of claim 14, wherein the gate electrode comprises openings to expose the electron emission regions and the effective line width of the gate electrode in the effective area is a difference between the line width of the gate electrode in the effective area and a total line width of opening portions placed in the width direction of the effective portion.

16. The electron emission device of claim 14, wherein the gate electrode further comprises a variable line width portion comprising a gradually increased line width to connect the gate electrode in the pad area to the gate electrode in the effective area.

17. An electron emission display, comprising:
the electron emission device of claim 14;
an external circuit connected to the gate electrode at the pad area to supply a driving voltage to the electron emission device;
a counter substrate facing the substrate;
phosphor layers formed on a surface of the counter substrate to emit light when excited by the emitted electrons; and
an anode electrode formed on a surface of the phosphor layers to accelerate the emitted electrons.

18. The electron emission display of claim 17, wherein the phosphor layers further comprise red, green, and blue phosphors spaced apart from each other by a black layer disposed between the respective phosphor layers.

19. The electron emission display of claim 17, wherein the anode electrode comprises an aluminum metallic material.
